(19) United States
(12) Patent Application Publication
(10) Pub. No.: US 2008/0108018 A1
(43) Pub. Date: May 8, 2008

(54) Bonding tooth and method for changing appearance of mouth using same

(76) Inventor: Yuji Miwa, Tokyo (JP)

Correspondence Address: KRATZ, QUINTOS & HANSON, LLP, 1420 K Street, N.W., Suite 400, WASHINGTON, DC, 20005, US

(21) Appl. No.: 11/635,497

(22) Filed: Dec. 8, 2006

(30) Foreign Application Priority Data
Nov. 6, 2006 (JP) 2006-299762

(51) Int. Cl. A61C 5/08; A61C 5/04

(52) U.S. Cl. 433/218; 433/226

(57) ABSTRACT

An artificial tooth is bonded to a malformed tooth without cutting the tooth, whereby a row of teeth is changed in a rapid and straightforward manner. The muscles surrounding the mouth cavity are pushed by the artificial tooth, thereby changing the appearance of the face. The present invention provides a bonding tooth (1) that is bonded to a tooth (T) in a row of malformed teeth so that muscles of the mouth in front of the maxillary and mandibular bodies, which muscles constitute most of the mouth muscles that control the appearance of the mouth, are subjected to pressure from an interior of the mouth cavity, and the appearance of the mouth is caused to change. The bonding tooth comprises a bonding tooth surface part (3) of a coloration similar to that of the tooth (T), a bonding tooth main body (2) of such a thickness that the mouth muscles are subjected to pressure and an optimal row of teeth are obtained, and a bonding surface (4) formed on a rear surface of the bonding tooth main body (2) and provided with a profiling surface so as to come into engagement with in the shape of an obverse surface of the tooth (T).

### BACKGROUND OF THE INVENTION

1. Field of the Invention

The present invention relates to a bonding tooth and to and a method for changing the appearance of the mouth using the bonding tooth, whereby an artificial tooth is bonded to a tooth and the appearance of the mouth is changed.

2. Description of the Related Art

Dentition and the shape and color of the teeth have a dramatic effect on the look of the face. People who have a radiant smile project a refreshing, clean, and bright image to those around them. Therefore, people with poor dentition; i.e., a row of malformed teeth, often undergo teeth-correcting procedures, cleaning and whitening, and other treatments from an early age.

Conversely, people having unattractive dentition or tooth color tend to feel self-conscious about their mouths. Females in particular feel especially insecure. The various states in which the teeth are misaligned have a great influence on the shape of the mouth. Examples of such states include “crowding,” “overjet,” “prognathia,” “apertognathia,” “overbite,” and “edge-to-edge occlusion.”

“Crowding,” also known as “double tooth” or “displacement,” is a state of dentition in which the maxilla and the mandible are not arranged in a clean accurate shape, and the teeth are misaligned. “Overjet,” also known as “buck-toothed,” is a state of dentition in which the upper teeth protrude outward on biting. Protruding teeth readily crack or cut the lips. “Prognathia,” also known as “underbite,” is a state in which the lower teeth protrude out more than the upper teeth on biting. “Apertognathia,” also known as “open bite,” is a state in which the front teeth do not fully close on biting, so the upper front teeth are not in alignment with the lower front teeth, forming a gap therebetween. “Overbite” is a state in which the front teeth are in such a deep alignment that the lower front teeth are not visible. “Edge-to-edge occlusion” is a state in which the upper and lower front teeth do not overlap on biting, and the ends of the teeth instead come into contact with each other. Prosthetic or other corrective procedures have traditionally been used to adjust such dental configurations.

### SUMMARY OF THE INVENTION

Such orthodontic corrections may, for example, be treatments involving the use of instruments comprising wires and brackets, and are corrective techniques whereby a great difference can be made in extremely small areas in regard to the increasing/reducing of the force used to move the teeth, the angle and speed at which the force is applied, and the like. Orthodontic corrections using wires are problematic in that they require a long treatment time; i.e., three to four years. Recently, methods of attaching wires to the rear side of the teeth so that the wires will not be prominent have been suggested. However, corrections made on the back side of the teeth require increasingly complex techniques.

The present inventors have directed their attention to the fact that the degree of unevenness in malformed teeth can differ. Specifically, if the teeth are in severe misalignment, orthodontic corrections that use wires such as described above are necessary. Although the shape of the mouth is affected, the inventors directed their attention to the fact that corrective procedures using wires are not always necessary when the unevenness of the dentition is not severe.

The inventors also focused on the fact that malformed teeth have a dramatic effect on the muscle groups that form the mouth and the shape of the face. For example, as shown in the descriptive drawings of the mimetic muscles (mouth muscles) in FIGS. 4 and 5, a majority of the mouth muscles that control the shape of the face originate in the front of the maxillary and mandibular bodies, concentrate towards tubercles set directly outside the corners of the mouth, and pass therethrough before spreading into moveable lips to contribute to the arrangement of the muscles of the mouth. The orbicularis oris, levator anguli oris, depressor anguli oris, and other muscles move under their own tension, and are supported to some degree by the tooth sockets and the row of teeth, whose position and form are held by these muscles. In other words, the appearance of the mouth is formed by the tooth sockets and the teeth.

The shape of the mouth, which is configured as described above, will change, the lips will recede, and the nasolabial sulcus will deepen if, e.g., a tooth is lost or the tooth sockets decrease in size. Similarly, poor dentition affects the muscles of the mouth and upsets the aesthetic balance of the face. The upper and lower occlusional relationship becomes unstable, the areas of contact between the upper and lower lips increase in size, and the shape of the mouth undergoes considerable further change.

Techniques for adjusting, improving, and restoring poor dentition have been proposed. One such example is an “occlusion adjustor” (Japanese Laid-open Patent Application 11-206786). The proposed occlusion adjustor comprises left and right bite plates fashioned into a long and thin planar shape of a desired thickness so as to be interposable between the molars of the person, and provided in a connected row arrangement on at least an outer side thereof, with cheek plates in a cross-sectional T-shape. A flexible synthetic resin material is used to mold the bite plates into an integrated unit. The left and right bite plates are aligned with a gap therebetween, in which state a bendable connection wire is used to integratedly connect the space between the distal ends thereof.

The muscles surrounding the mouth cavity are attached to the skeletal structure in bilateral symmetry. Therefore, if the volume of the mouth cavity decreases and the balance of the movement of the muscles is disturbed, the size and shape of the left and/or right eye will change, the lips will change in thickness and shape, the lengths of the limbs will change, or other changes will occur to the face and body. Such changes result in headaches, stiff shoulders, hip pain, knee pain, or walking difficulties accompanying movements made during everyday life. The “occlusion adjustor” of Japanese Laid-open Patent Application 11-206786 has the effect of ameliorating these various symptoms.

The “occlusion adjustor” of Japanese Laid-open Patent Application 11-206786 is highly effective in improving bite, but cannot change the shape of the mouth, which is an object of the present invention.

The present invention was devised to solve these problems. Specifically, it is an object of the present invention to provide a bonding tooth and a method for changing mouth appearance wherein the bonding tooth is used, whereby an artificial tooth is bonded to a misaligned tooth without involving cutting of the tooth. As a result, a row of teeth is readily changed in a short period of time, and the peripheral muscles of the mouth cavity are pressed by the artificial tooth, thereby allowing the shape of the mouth to be changed.

The bonding tooth of the present invention is a bonding tooth (1) that is bonded to a tooth (T) in a row of malformed teeth so that muscles of the mouth in front of maxillary and mandibular bodies, which muscles constitute most of the mouth muscles controlling mouth appearance, are subjected to pressure from an interior of the mouth cavity, and the appearance of the mouth is caused to change, the bonding tooth comprising a bonding tooth surface part (3) of a coloration similar to that of the tooth (T), a bonding tooth main body (2) of such a thickness that the mouth muscles are subjected to pressure and an optimal row of teeth is obtained, and a bonding surface (4) formed on a rear surface of the bonding tooth main body (2) and provided with a profiling surface so as to engage with the shape of an obverse surface of the tooth (T).

In particular, the bonding tooth for changing the shape of the mouth is a bonding tooth (1) that is bonded to a specific tooth (T) in a row of teeth so that specific muscles of the mouth in front of the maxillary and mandibular bodies, which muscles constitute most of the mouth muscles controlling the shape of the mouth, are subjected to pressure from an interior of the mouth cavity and the shape of the mouth is caused to change, the bonding tooth comprising a bonding tooth surface part (3) of a coloration similar to that of the tooth (T), a bonding tooth main body (2) of such a thickness that the mouth muscles are subjected to pressure and held upward, and a bonding surface (4) formed on a rear surface of the bonding tooth main body (2) and provided with a profiling surface so as to engage with the shape of an obverse surface of the tooth (T).

The bonding tooth main body (2) is preferably formed to a small thickness in an area bonded to a root region (Ta) of the tooth (T), and preferably formed to a large thickness in a middle region (Tb) and distal region (Tc) thereof.

A plurality of bonding teeth (1) can be connected.

Fine irregularities for increasing the bonding strength of cement are preferably formed on the bonding surface (4) of the bonding tooth (1).

The bonding tooth (1) is made of a plastic, ceramic, or other material.

A pattern can be formed on the bonding tooth surface part (3) of the bonding tooth (1).

In the method for changing the appearance of the mouth according to the present invention, a bonding tooth (1) is bonded to a tooth (T) in a row of malformed teeth, whereby mouth appearance is changed, the method for changing the appearance of the mouth by using a bonding tooth comprising making a cast for the row of malformed teeth using an impression material (S1); bonding the cast impression material as a base to a tooth (T) in a specific region to form an optimal row of teeth and to form a bonded tooth (1) of such a thickness as to enable a mouth muscle to be subjected to pressure from within a mouth cavity (S5); and cementing the resulting bonding tooth (1) to the tooth (T) that is the cause of the malformed teeth (S6, S7).

Bonding teeth (1) of different thicknesses may, for example, be individually bonded to each tooth in the entire set of maxillary and mandibular teeth.

A bonding tooth (1) can be created while measuring an optimal thickness and shape for the tooth (1) using facial contour lines.

Furthermore, in the method for changing the appearance of the mouth according to the present invention, a bonding tooth (1) is bonded to a specific tooth (T), whereby mouth appearance is changed, the method for changing the appearance of the mouth by using a bonding tooth comprises creating a bonding tooth (1) that is bonded to a tooth (T) in a specific position, that applies pressure to the orbicularis oris, levator anguli oris, depressor anguli oris, or another muscle that forms the muscles of the mouth, and that has sufficient thickness to hold the muscles upward (S5); and cementing the resulting bonding tooth (1) on the tooth (T) that is in a position for pushing a specific mouth muscle (S6, S7).

In order to adjust the width of the lips (L), the bonding tooth (1) may, for example, be bonded from the medial incisor (T1) to the canine (T3), which are in a position for holding up the orbicularis oris.

The bonding tooth (1) is bonded to the bicuspid (T5) group in a position for holding up the orbicularis oris in order to adjust the width of a lip (L) while simultaneously raising a corner of the mouth.

The bonding tooth (1) is bonded to the bicuspid (T5) group and the molar (T6) group in a position for holding up the zygomaticus major that acts together with the zygomaticus minor, the levator labii superioris, and the levator labii superioris alaeque nasi disposed superficially with regard to the face, and that holds up these mouth muscles so as to hold up a whole cheek.

The bonding tooth (1) can be bonded to a tooth in a specific position in the mandible.

The bonding tooth (1) of the present invention is bonded to a specific tooth (T) or a concave tooth (T) within a row of malformed teeth, and pushes the orbicularis oris, levator anguli oris, the depressor anguli oris, or other mouth muscles upward or downward from within the mouth cavity in the front of the maxillary and mandibular bodies, whereby the shape of the mouth of the person can be changed. In other words, a concave tooth (T) in a specific position within a row of teeth effects a change in the mouth muscles and enables an aesthetic imbalance in the face to be rectified. Moreover, the shape of the face can be improved while also allowing the upper and lower occlusional relationship to stabilize without enlarging the area of contact between the upper and lower lips (L).

In particular, no teeth are cut in the present invention; therefore, dentition can be corrected straightforwardly in a short period of time, and the shape of the mouth of a person can be changed.

The changing method of the present invention does not require the use of wires or brackets, and allows a variety of mouth forms to be obtained by re-bonding a bonding tooth (1) without requiring two to three years or an otherwise long period of time.

Moreover, the bonding tooth is bonded to the front surface of the teeth, which not only changes the orientation and shape of the tooth, but allows dull-colored teeth to be given a white finish.

Particularly when a bonding tooth (1) is bonded from the medial incisor (T1) to the canine (T3), the orbicularis oris is held up, and the width of the lips (L) is adjusted within the shape of the mouth, whereby the vermillion border (L1) is inverted, and so-called thin lips (L) are made thicker.

When a bonding tooth (1) is bonded to the bicuspid (T5) group, the levator anguli oris is held up, the zygomaticus major that acts in concert with the levator anguli oris is pulled up and back, and the whole cheek is lifted up. The depressor anguli oris, which also acts in concert with the levator anguli oris, is also pulled up, refining the line of the jaw. The orbicularis oculi, which is connected to the zygomaticus major, is also affected, allowing the skin around the eyes to be lifted.

When a bonding tooth (1) is bonded to the bicuspid (T5) group and the molar (T6) group, the zygomaticus major is raised along with the levator labii superioris alaeque nasi, the levator labii superioris, and the zygomaticus minor, which are superficially positioned with regard to the face and act in concert with the zygomaticus major, whereby the whole cheek can also be raised.

### BRIEF DESCRIPTION OF THE DRAWINGS

FIG. 1 is a flowchart showing a method for changing mouth appearance in which the bonding tooth of Embodiment 1 is used;

FIG. 2 shows an example of a bonding tooth used on a medial incisor, with FIG. 2A being an enlarged front view, FIG. 2B being an enlarged cross-sectional view, FIG. 2C being a front view of a front row of teeth to which the bonding tooth is bonded, and FIG. 2D being a front view of a row of teeth with a bonding tooth bonded to a specific tooth;

FIG. 3 shows an example of a bonding tooth used on a molar, with FIG. 2A being an enlarged front view, FIG. 2B being an enlarged cross-sectional view, FIG. 2C being a front view of a front row of teeth to which the bonding tooth is bonded, and FIG. 2D being a front view of a row of teeth with the bonding tooth bonded to a specific tooth;

FIG. 4 is a descriptive front view showing the positional relationships between the maxillary row of teeth and the mouth muscles;

FIG. 5 is a descriptive side view showing the mouth muscles;

FIG. 6 is a descriptive cross-sectional side view showing the state of change between a tooth and the mimetic muscles in FIG. 4, with FIG. 6A showing the positional relationship between a medial incisor and a lip, and FIG. 6B showing the positional relationship between a canine and a lip;

FIG. 7 is a descriptive cross-sectional side view showing the state of change between a tooth and the mimetic muscles in FIG. 4, with FIG. 7C showing the positional relationship between a bicuspid and a mimetic muscle, and FIG. 7D showing the positional relationship between a molar and a mimetic muscle;

FIG. 8 is a descriptive drawing showing a physical model of a muscle;

FIG. 9 shows a six-tooth-wide bonding tooth of Embodiment 2, wherein a plurality of bonding teeth is connected, with FIG. 9A being a front view, and FIG. 9B being a top view; and

FIG. 10 shows a five-tooth-wide bonding tooth of Embodiment 2, wherein a plurality of bonding teeth is connected, with FIG. 10A being a front view, and FIG. 10B being a top view.

### DESCRIPTION OF THE PREFERRED EMBODIMENTS

The present invention provides a bonding tooth and a changing method in which an artificial tooth is bonded to a tooth, and the mouth muscles that control the shape of the human mouth are subjected to pressure from within the mouth cavity by the bonding tooth, whereby tension in the mouth muscles is relieved and the shape of the human mouth is changed.

### Embodiment 1

A preferred embodiment of the present invention will be described below with reference to the drawings.

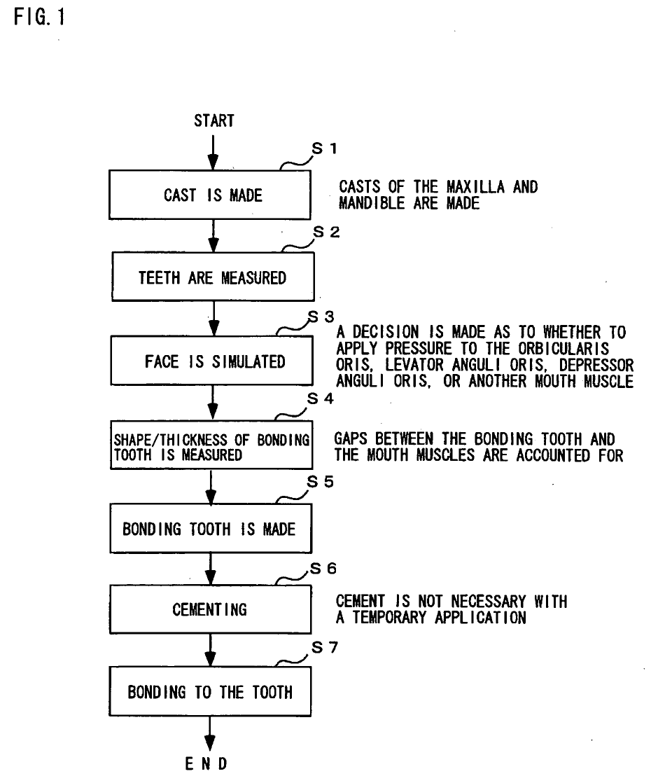

FIG. 1 is a flowchart showing a method for changing the appearance of the mouth using the bonding tooth of Embodiment

According to the method for changing the appearance of the mouth using the bonding tooth according to the present invention, first, a cast is made for a row of teeth using an impression material, as illustrated. For example, if casts are made of the row of teeth on the maxilla and mandible, and the two sets of back teeth (bicuspids and the molars) are slightly indented towards the inner side, then the indentation greatly influences the appearance of the mouth. Therefore, an examination is performed as to whether or not to bond the bonding tooth to a tooth T.

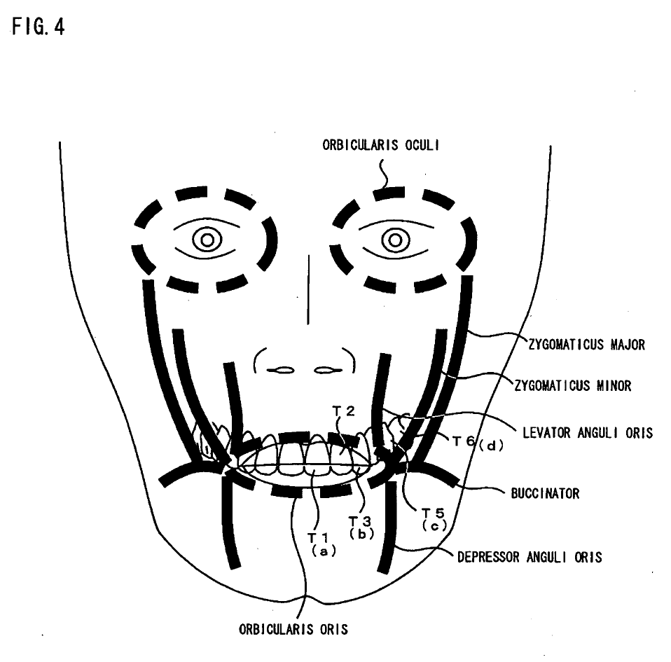

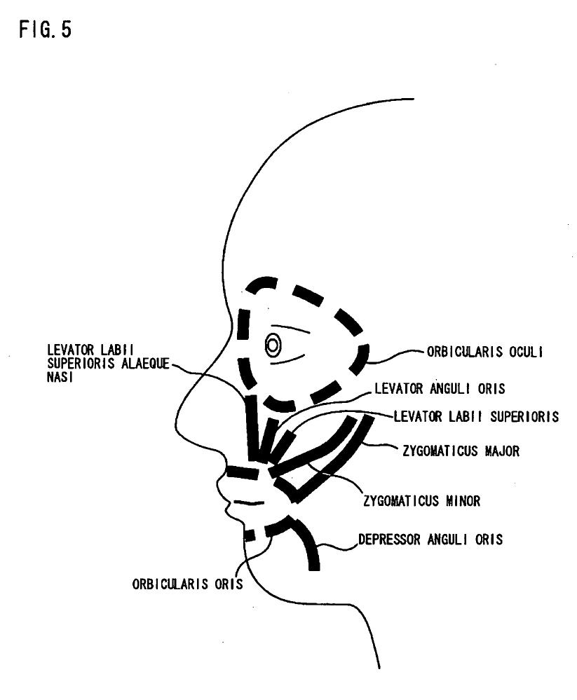

Next, using the cast made from the impression material as a base, the teeth are measured (S2), and the bonding tooth 1 to be bonded to the tooth T in a specific position is created (S5). An image of the face is entered into a computer, and a simulation of the indented mouth or facial distortion is made from the image as relates to the bonding tooth 1 (S3). Based on the face simulation (S3), the shape and thickness of the bonding tooth 1 are measured so that the orbicularis oris, the levator anguli oris, and the depressor anguli oris shown in FIGS. 4 and 5 will be subjected to pressure from within the mouth cavity (S4), and the bonding tooth is created in a form that compensates for the indentation or distortion (S5). Specifically, the bonding tooth 1 is bonded with cement to the recessed tooth T of the malformed teeth (S6, 7), whereby an optimal row of teeth is formed. The thickness of the bonding tooth 1 is usually in a range of from 0.5 to 3.0 mm. If the bonding tooth 1 is only for a temporary application, a pressure-sensitive adhesive is used instead of cement.

An object of the bonding tooth 1 of the present invention is not merely to correct rows of malformed teeth, but to bond the bonding tooth 1 to the recessed tooth T and thereby change the appearance of the mouth. Therefore, the thickness and form of the bonding tooth 1 have an important significance. Once the bonding tooth 1 is fitted during casting, the shape in which the mouth is to appear is specified while a facial simulation is carried out (S3). Alternatively, the bonding tooth 1 is created while the optimal thickness and shape thereof are measured using facial contour lines. For example, if the maxillary and mandibular molars are to be bonded, then a bonding tooth 1 that is thicker than one used for the front teeth is bonded to the molars to so as to push the zygomaticus major and the levator anguli oris upward or downward.

The resulting bonding tooth 1 is cemented to the tooth T that is causing the malformed teeth. For example, the bonding tooth 1 is bonded to a tooth T in a specific position in an indented row of teeth so as to push the levator anguli oris of the mouth muscles. In the present invention, the bonding tooth 1 is bonded to the specific recessed tooth T in a row of malformed teeth without the teeth being cut, whereby the teeth can be straightforwardly changed in a short period of time, and the appearance of the mouth can be changed. Moreover, the method of the present invention does not involve the use of wires or brackets; therefore, the bonding tooth can be exchanged to change the appearance of the face without a long period of time such as two to three years being required.

In order for a change to be made mainly to the appearance of the face, the bonding tooth 1 is made to apply pressure to the mouth muscles when bonded to a specific tooth T in a row of teeth, a measurement is taken of the extent to which the mouth muscles will be held up, and the thickness of the bonding tooth 1 is decided. A measurement is taken of the extent to which the mouth muscles should be held up because it is not merely the aesthetics of the teeth that will change, but the appearance of the face as well.

The bonding tooth 1 is not only bonded to a recessed tooth T, but thin bonding teeth 1 are also bonded in the vicinity thereof. This allows the row of teeth to be adjusted while also allowing metal crowns, tetracycline coloring, and so forth to be hidden.

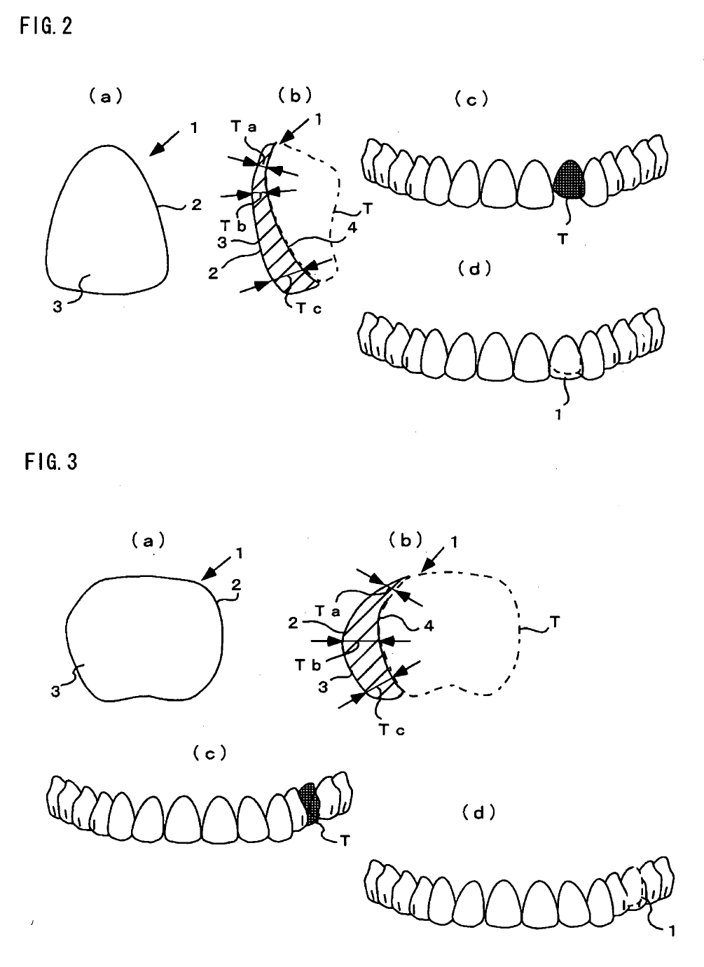

FIG. 2 shows an example of a bonding tooth used on a medial incisor. FIG. 2A is an enlarged front view, FIG. 2B is an enlarged cross-sectional view, FIG. 2C is a front view of a front row of teeth to which the bonding tooth is bonded, and FIG. 2D is a front view of a row of teeth with a bonding tooth bonded to a specified tooth. FIG. 3 shows an example of a bonding tooth used on a molar. FIG. 3A is an enlarged front view, FIG. 3B is an enlarged cross-sectional view, FIG. 3C is a front view of a front row of teeth to which the bonding tooth is bonded, and FIG. 3D is a front view of a row of teeth with the bonding tooth bonded to a specified tooth. The teeth in the drawings are shown protruding from the gums.

The bonding tooth 1 of the present invention comprises a bonding tooth surface part 3 on the obverse surface of a bonding tooth main body 2, and a bonding surface 4 on the reverse surface of the bonding tooth main body 2. The tooth is created from a plastic, ceramic, or other material. The bonding tooth main body 2 pushes the mouth muscles from within the mouth cavity, and has a thickness large enough to form an optimal row of teeth. A bonding tooth surface part 3 that has the same coloring as a tooth T is formed on the obverse surface side of the bonding tooth main body 2. The bonding surface 4 on the rear surface of the bonding tooth main body 2 is provided with a profiling surface so as to come into engagement with the shape of an obverse surface of the recessed tooth. The bonding tooth main body 2 and the bonding tooth surface part 3 may be made of the same material or different materials bonded together.

As shown in FIG. 2D, a bonding tooth for a medial incisor is bonded to a recessed tooth T, which is colored black in the row of teeth in FIG. 2C. The bonding tooth is bonded in only one location in the illustrated example, but several other thin bonding teeth 1 can also be bonded in the vicinity as described above. This is because the bonding tooth 1 used for medial incisors and lateral incisors has the important function of contributing brightness to the teeth, or the mouth, by reflecting so-called outside light.

The thickness of the bonding tooth 1 of the present invention is determined according to the state of the tooth T to which the bonding tooth is bonded. A bonding tooth 1 bonded to a recessed tooth T in a row of malformed teeth is formed so as to protrude enough to push the mouth muscles from within the mouth cavity in the front of the maxillary and mandibular bodies, which comprise a large part of the mouth muscles. For example, as shown in FIG. 2B, in the bonding tooth main body 2 of a bonding tooth used for medial incisors, the region bonded to the root part Ta of the tooth T is thinner, and the region of the middle part Tb and tip part Tc is thicker. The thick part of the middle region Tb has the function of pushing up the mouth muscles from within the mouth cavity.

Similarly, as shown in FIG. 3B, in the main body 2 of a bonding tooth used for molars, the thickness of the region bonded to the root part Ta of the tooth T is thinner, and the region that is bonded to the middle part Tb and tip part Tc is thicker. The thick part of the middle part Tb has the function of pushing up the mouth muscles from within the mouth cavity. As shown in FIG. 3D, the bonding tooth 1 used for molars is cemented to a recessed tooth T, which is colored black in the row of teeth in FIG. 3C.

The bonding tooth 1 of the present invention is bonded to a tooth T in a specific position in the maxillary or mandibular row of teeth so as to push the zygomaticus major and the levator anguli oris mouth muscles. Alternatively, bonding teeth 1 of varying thicknesses are bonded to all teeth T in the rows of teeth. Thus, when bonded to the whole row of teeth, the bonding teeth not only change the direction and form of the teeth, but also allow dull-colored teeth to be given a white finish.

Fine irregularities for increasing the bonding strength of the cement are formed on the bonding surface 4 of the bonding tooth 1, making the bonding tooth less readily detachable, and allowing the tooth to be stably attached.

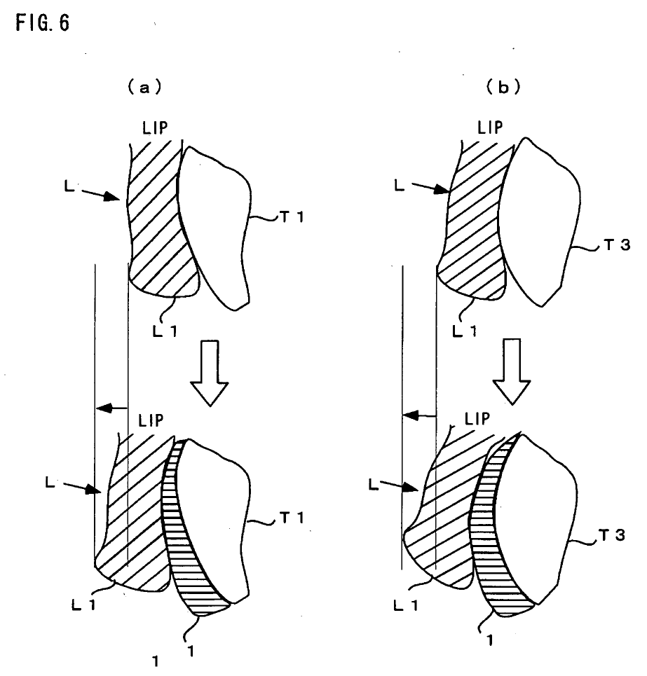

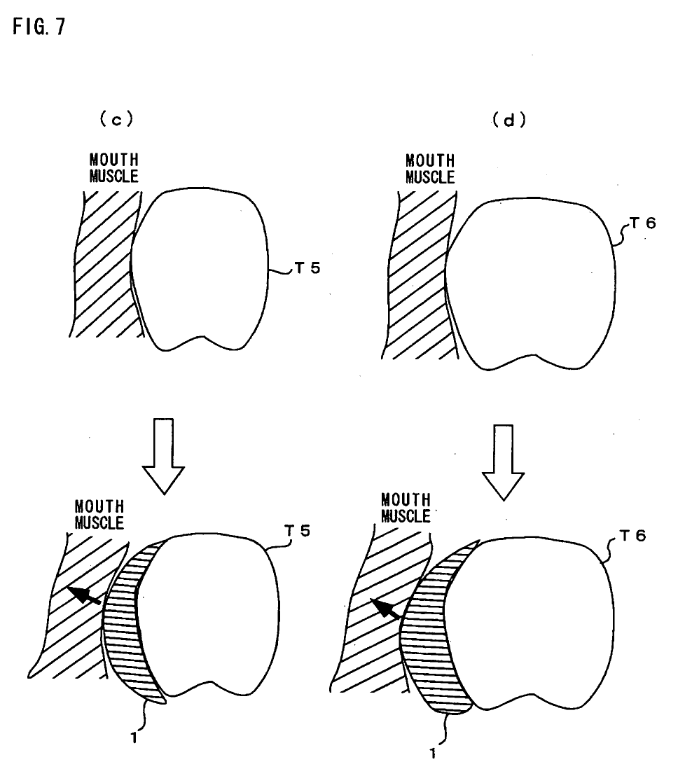

FIG. 4 is a descriptive front view showing the positional relationships between the maxillary teeth and the mimetic muscles (mouth muscles). FIG. 5 is a descriptive side view showing the mimetic muscles (mouth muscles). FIG. 6 is a descriptive cross-sectional side view showing the state of change between the teeth and the mimetic muscles in FIG. 4, with FIG. 4A showing the positional relationship between a medial incisor and the lips, and FIG. 4B showing the positional relationship between a canine and the lips. FIG. 7 is a descriptive cross-sectional side view showing the state of change with regard to the mimetic muscles in FIG. 4, with FIG. 4C showing the positional relationship between a bicuspid and the mouth muscles, and FIG. 4D showing the positional relationship between a molar and the mouth muscles.

To change the appearance of the mouth, a bonding tooth 1 thick enough to apply pressure to the orbicularis oris, the levator anguli oris, the depressor anguli oris, and other muscles forming the muscles of the mouth, and hold up these muscles is bonded to a specific tooth T. For example, as shown in FIGS. 6A and 6B, a bonding tooth 1 is bonded to a medial incisor T1 and a canine T3 that are in positions for holding up the orbicularis oris in order to adjust the width of the lip L. Thus, when bonding teeth 1 are bonded from the medial incisor T1 to the lateral incisor T2 and canine T3, the orbicularis oris is held up, and the width of the lip L within the appearance of the face is adjusted, whereby the vermillion border (L1) is inverted, and so-called thin lips (L) become thicker.

As shown in FIG. 7C, a bonding tooth 1 is bonded to a bicuspid T5 in a position for holding up the mouth muscles (the orbicularis oris) in order to adjust the width of the lip L and raise the corners of the mouth. The orbicularis oris is a muscle that encircles the mouth, and either closes the mouth or pushes out the lips. The orbicularis oris is a mimetic muscle (mouth muscle) that is regarded to make the face look older as it weakens. Therefore, by holding the orbicularis oris, the bonding tooth 1 of the present invention changes the appearance of the mouth in a subtle way, and keeps the mouth firm.

As shown in FIG. 7D, a bonding tooth 1 is bonded to a bicuspid T5 and a molar T6 in a position for holding up the zygomaticus major. The zygomaticus major acts together with the levator labii superioris alaeque nasi, the levator labii superioris, and the zygomaticus minor, which are disposed superficially with regard to the face, so as to hold up the whole cheek. The zygomaticus major raises the corners of the mouth high to create a smile. The zygomaticus major is pushed upwards by the bonding tooth 1, thereby allowing crow's feet around the mouth to be eliminated and wrinkles to be stretched, leaving the skin looking invigorated.

When a bonding tooth 1 is bonded to the bicuspid T5 group, the levator anguli oris is held up, the zygomaticus major, which is linked to the levator anguli oris, is pulled up and back, and the whole cheek is lifted up. The depressor anguli oris, which is linked to the levator anguli oris, is also pulled up, and the line of the jaw is sharpened as a result. The orbicularis oculi, which is connected to the zygomaticus major, is also affected, so that the skin around the eyes is raised. The pushing up of the zygomaticus major by the bonding tooth 1 allows crow's feet to be eliminated and wrinkles to be stretched. The depressor anguli oris is a muscle that pulls the corners of the mouth directly and obliquely downward. When the depressor anguli oris weakens, vertical wrinkles tend to appear from the corners of the mouth to the lower chin. The depressor anguli oris is pulled up and back by the bonding tooth 1, and accordingly the whole cheek can be lifted up. The orbicularis oculi is a muscle that encircles the eyes, which are opened and closed thereby. The overall body of the orbicularis oculi is thin, and accordingly tends to move rapidly and create wrinkles; however, the mimetic muscles linked thereto also serve to stretch these wrinkles.

When a bonding tooth 1 is bonded to the bicuspid T5 group and the molar T6 group, the zygomaticus major is lifted up, and the zygomaticus minor, the levator labii superioris, and the levator labii superioris alaeque nasi disposed superficially with regard to the face and act together with the zygomaticus major, are also held up, thereby holding up the cheek. The zygomaticus minor pulls the corners of the mouth up at an angle and is an important muscle in forming a smile. This muscle removes tension from the cheek, which results in a natural smile. The zygomaticus minor is pushed up by the bonding tooth 1, whereby a slack cheek caused by weakness of the zygomaticus minor can be stretched.

The bonding tooth 1 of the present invention is not necessarily bonded solely to maxillary teeth T, and can also be bonded to mandibular teeth T in specific positions. For example, if a lip L is thin, bonding teeth 1 are bonded to upper and lower teeth T so that the upper and lower vermillion borders L1 will be shown.

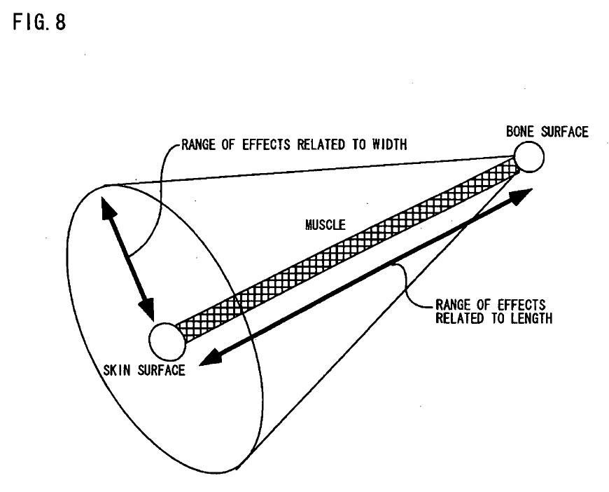

FIG. 8 is a descriptive drawing showing a physical model of a muscle.

As shown, the mimetic muscles (mouth muscles) comprise plate-type muscles such as the zygomaticus major and risorius, and annular muscles such as the orbicularis oculi and the orbicularis oris. The annular muscle is modeled by processing on plate-type, muscle model parameters to a certain degree, segmenting and connecting the results, and forming a connected loop. Specifically, stimulating and moving the middle part (region affecting the length) of the muscle that is connected to the bone surface has a dramatic effect on the surface of the skin (region affecting the width) connected to the multiple ends of the muscle. This means that changing the muscles that move the skin surface causes the appearance of the skin to change dramatically.

According to the present invention, the middle (area affecting length) of the mimetic muscles (mouth muscles) is stimulated and moved by the bonding tooth 1, whereby the skin surface (area affecting width) is dramatically affected.

### Embodiment 2

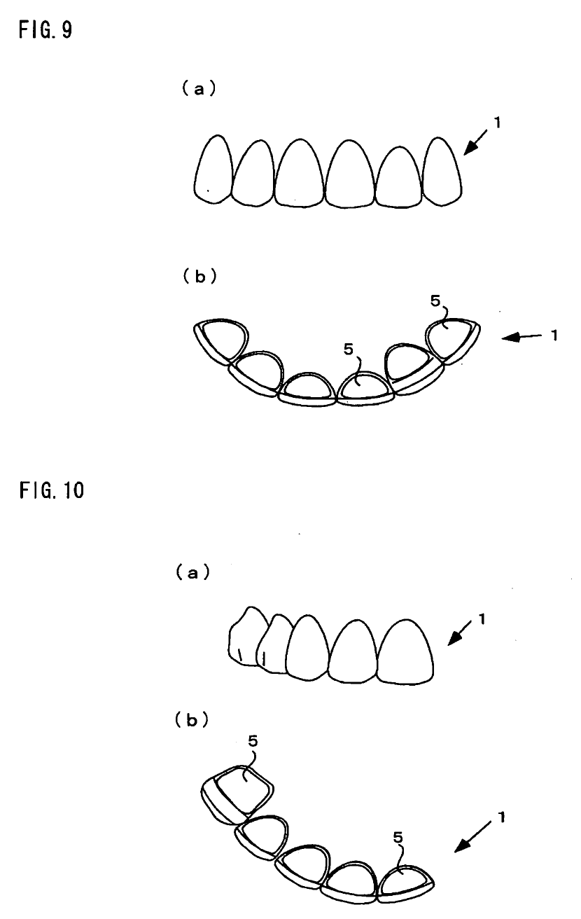

FIG. 9 shows a plurality of the bonding teeth used in Embodiment 2, which are connected together for use on six teeth. FIG. 9A is a front view, and FIG. 9B is a top view. FIG. 10 shows a plurality of the bonding teeth used in Embodiment 2, which are connected together for use on five teeth. FIG. 10A is a front view, and FIG. 10B is a top view.

Several bonding teeth 1 are connected together in Embodiment 2. If a plurality of recessed teeth T is present, then a plurality of bonding teeth 1 must be bonded thereto. The bonding teeth 1 can be linked on the sides of the main bodies 2 of the bonding tooth. For example, a bonding tooth 1 used for the medial incisors has the function of reflecting outside light and imparting brightness to the row of teeth, i.e., the mouth. Accordingly, six bonding teeth 1 are preferably connected in order to be bondable on the six teeth from the medial incisors T1 to the lateral incisors T2 and canines T3. The linked bonding teeth are used by inserting the teeth T into pockets 5 that comprise a transparent resin. The use of five or six teeth is for purposes of example; as long as two or more are used, the number of teeth is not limited to the number given in the illustrated examples.

Inserting the teeth T into the pockets 5 enables the linked bonding teeth 1 to be mounted, which is suitable for temporary mounting.

A design (not shown) can be formed on the surface part 3 of the bonding tooth 1. For example, a bonding tooth 1 having a prescribed pattern inscribed on the surface part 3, or a bonding tooth 1 to which has been bonded a sheet-like object having a pattern thereon, can be bonded to one or several bonding teeth 1 used for medial incisors, or one or several bonding teeth 1 used for lateral incisors.

According to the present invention, a bonding tooth 1 is thus bonded to a recessed tooth T in a row of teeth. The muscles of the mouth in front of the maxillary and mandibular bodies, which muscles constitute most of the mouth muscles, are pressed so as to be pushed upward and outward (maxillary muscles), or downward and outward (mandibular muscles) The appearance of the mouth can be changed thereby. Specifically, it is possible to have an effect on mouth muscles changed by a recessed tooth in a row of malformed teeth, as well as to ameliorate any imbalance in the aesthetic appearance of the face. The appearance of the face can be improved irrespectively of the upper and lower occlusional relationship.

Examples in which the bonding tooth 1 of the present invention is bonded to change the appearance of the mouth will be described below.

### BONDING EXAMPLE 1

The bonding of a bonding tooth 1 to the maxillary teeth of a person who has a prominent metal crown can make the mouth look less severe. For example, a metal crown on the second maxillary bicuspid will be concealed by the bonding tooth 1, whereby the face will be given a smoother appearance.

### BONDING EXAMPLE 2

The bonding of a bonding tooth 1 to the maxillary or mandibular row of teeth of a person with prominent tetracycline coloring will reduce the degree to which the tetracycline coloring stands out, and the mouth can be given a brighter appearance.

### BONDING EXAMPLE 3

The bonding of a bonding tooth 1 to the first and second bicuspids of a person having prominent facial distortion will eliminate darkness on the left or right side of the face and remove the facial distortion. In addition, the teeth themselves will be whitened by the bonding tooth 1, thereby giving the person the appearance of looking younger.

### BONDING EXAMPLE 4

The bonding of a bonding tooth 1 to the entire maxillary row of teeth of a person having prominent distorted mouth corners will eliminate the distortion in the corners of the mouth, and allow the mouth to be made more taut.

### BONDING EXAMPLE 5

The bonding of bonding teeth 1 to the medial incisors, lateral incisor, and first and second bicuspids of a person having prominent front teeth will raise the corners of the mouth, and make their face look more toned.

### BONDING EXAMPLE 6

The bonding of bonding teeth 1 to the entire maxillary row of teeth of a person with a sullen expression will produce a cheerier-looking mouth.

### BONDING EXAMPLE 7

The bonding of bonding teeth 1 to the entire maxillary row of teeth of a person with a dark mouth will conceal double teeth, and allow the darkness of the mouth to be eliminated.

The present invention is not limited to the aforedescribed embodiments. It shall be apparent that the present invention is not limited to the illustrated configurations, and a variety of modifications can be made to the invention without departing from the scope thereof, as long as the bonding of a bonding tooth to a tooth in a mouth of a person having poor dentition readily transforms a row of teeth in a rapid and straightforward manner without the tooth or teeth being cut, and the muscles in the periphery of the mouth cavity are pushed by the bonding tooth 1 so that the appearance of the mouth is changed.

The bonding tooth and the method for changing the appearance of the mouth in which the bonding tooth is used according to the present invention do not require any teeth to be cut. Therefore, the invention can be used in a variety of applications; e.g., as a tooth that can be temporarily attached and then removed when a photograph needs to be taken.

1. A bonding tooth (1) that is bonded to a tooth (T) in a row of malformed teeth so that muscles of the mouth in front of maxillary and mandibular bodies, which muscles constitute most of the mouth muscles controlling mouth appearance, are subjected to pressure from an interior of the mouth cavity, and the appearance of the mouth is caused to change, the bonding tooth comprising:
a bonding tooth surface part (3) having a coloration similar to that of the tooth (T);
a bonding tooth main body (2) having such a thickness such that the mouth muscles are subjected to pressure and an optimal row of teeth is obtained; and
a bonding surface (4) formed on a rear surface of the bonding tooth main body (2) and provided with a profiling surface so as to engage with the shape of an obverse surface of the tooth (T).

2. A bonding tooth (1) that is bonded to a specific tooth (T) in a row of teeth so that specific muscles of the mouth in front of maxillary and mandibular bodies, which muscles constitute most of the mouth muscles controlling mouth appearance, are subjected to pressure from an interior of the mouth cavity and the shape of the mouth is caused to change, the bonding tooth comprising:
a bonding tooth surface part (3) having a coloration similar to that of the tooth (T);
a bonding tooth main body (2) having such a thickness such that the mouth muscles are subjected to pressure and held upward; and
a bonding surface (4) formed on a rear surface of the bonding tooth main body (2) and provided with a profiling surface so as to engage with in the shape of an obverse surface of the tooth (T).

3. (canceled)

4. The bonding tooth of claim 1, wherein a plurality of bonding teeth (1) is connected.

5. (canceled)

6. (canceled)

7. (canceled)

8. (canceled)

9. A method for changing mouth appearance by using a bonding tooth (1) in which the bonding tooth is bonded to a tooth (T) in a row of malformed teeth, whereby mouth appearance is changed, the method comprising:
making a cast for the row of malformed teeth using an impression material (S1);
bonding the cast impression material as a base to a tooth (T) in a specific region to form an optimal row of teeth and to form a bonded tooth (1) having a thickness so as to enable a mouth muscle to be subjected to pressure from within a mouth cavity (S5); and
cementing the resulting bonding tooth (1) to the tooth (T) that is the cause of the malformed teeth (S6, S7).

10. (canceled)

11. The method of claim 9 for changing mouth appearance by using a bonding tooth, wherein the bonding tooth (I) can be created while measuring an optimal thickness and shape for the tooth (I) using facial contour lines.

12. A method for changing mouth appearance by using a bonding tooth, wherein a bonding tooth (1) is bonded to a specific tooth (T), whereby mouth appearance is changed, the method comprising:
creating a bonding tooth (1) that is bonded to a tooth (T) in a specific position, that applies pressure to the orbicularis oris, levator anguli oris, depressor anguli oris, or another muscle that forms the muscles of the mouth, and that has sufficient thickness to hold the muscles upward (S5); and
cementing the resulting bonding tooth (1) on the tooth (T) that is in a position for pushing a specific mouth muscle (S6, S7).

13. The method of claim 12 for changing mouth appearance by using a bonding tooth, wherein the bonding tooth (1) is bonded from the medial incisor (T1) to the canine (T3), which are in a position for holding up the orbicularis oris, in order to adjust the width of a lip (L).

14. The method of claim 12 for changing mouth appearance by using a bonding tooth, wherein the bonding tooth (1) is bonded to the bicuspid (T5) group in a position for holding up the orbicularis oris in order to adjust the width of a lip (L) while simultaneously raising a corner of the mouth.

15. The method of claim 12 for changing mouth appearance by using a bonding tooth, wherein the bonding tooth (1) is bonded to the bicuspid (T5) group and the molar (T6) group in a position for holding up the zygomaticus major that acts together with the zygomaticus minor, the levator labii superioris, and the levator labii superioris alaeque nasi disposed superficially with regard to the face, and that holds up these mouth muscles so as to hold up a whole cheek.

16. The method of claim 12 for changing mouth appearance by using a bonding tooth, wherein the bonding tooth (1) is bonded to a tooth in a specific position of the mandible.

17. The bonding tooth of claim 2, wherein the bonding tooth main body (2) is formed to a small thickness in an area for bonding to a root region (Ta) of the tooth (T), and formed to a large thickness in a middle region (Tb) and distal region (Tc) thereof.

18. The method of claim 10 for changing mouth appearance by using a bonding tooth, wherein the bonding tooth (1) can be created while measuring an optical thickness and shape for the tooth (1) using facial contour lines.

19. The method of claim 13 for changing mouth appearance by using a bonding tooth, wherein the bonding tooth (1) is bonded to a tooth in a specific position of the mandible.

20. The method of claim 14 for changing mouth appearance by using a bonding tooth, wherein the bonding tooth (1) is bonded to a tooth in a specific position of the mandible.
